(19) United States
(12) Patent Application Publication
(10) Pub. No.: US 2006/0150736 A1
(43) Pub. Date: Jul. 13, 2006

(54) Apparatus and method for analyzing semiconductor device

(76) Inventor: Susumu Akamatsu, Osaka (JP)

Correspondence Address: PANASONIC PATENT CENTER;c/o MCDERMOTT WILL & EMERY LLP, 600 13TH STREET, NW, WASHINGTON, DC, 20005-3096, US

(21) Appl. No.: 11/191,950

(22) Filed: Jul. 29, 2005

(30) Foreign Application Priority Data
Jan. 7, 2005 (JP) 2005-002712

(51) Int. Cl. G01H 13/00; G01N 29/04

(52) U.S. Cl. 73/579

(57) ABSTRACT

An apparatus for analyzing a semiconductor device has a stage for horizontally holding a semiconductor substrate serving as a target sample to be analyzed, an ultrasonic wave transmitting/receiving unit provided above the stage to transmit and receive an ultrasonic wave, a current control unit for applying a current to the ultrasonic wave transmitting/receiving unit such that the value of the current is variable, an ultrasonic wave transmitter provided in the ultrasonic wave transmitting/receiving unit to transmit an emitted ultrasonic wave to the target sample such that the frequency of the emitted ultrasonic wave is variable with changes in the value of the current applied from the current control unit, an ultrasonic wave receiver provided in the ultrasonic wave transmitting/receiving unit to receive a reflected ultrasonic wave which is the emitted ultrasonic wave transmitted from the ultrasonic wave transmitter and reflected from the target sample, and a position control unit for controlling at least one of the stage and the ultrasonic wave transmitting/receiving unit such that either one or both of them are movable in a horizontal direction. The apparatus for analyzing a semiconductor device also analyzes the target sample based on the frequency of the reflected ultrasonic wave having an amplitude thereof enlarged by resonance between the emitted ultrasonic wave and an unanalyzed material in the target sample and on the analysis position information of the target sample obtained from the position of at least one of the stage and the ultrasonic wave transmitting/receiving unit.

### CROSS-REFERENCE TO RELATED APPLICATIONS

The teachings of Japanese Patent Application JP 2005-002712, filed Jan. 7, 2005, are entirely incorporated herein by reference, inclusive of the specification, drawings, and claims.

### BACKGROUND OF THE INVENTION

The present invention relates to an apparatus and method for analyzing a semiconductor device.

With the recent trend toward larger-diameter silicon wafers, the evaluation of processing uniformity has become more and more important and the number of data items that should be acquired to evaluate processing uniformity has also increased.

As a conventional method for analyzing the structure of a semiconductor device, there has been known one which analyzes a cross section using SEM (Scanning Electron Micrograph) or TEM (Transmission Electron Micrograph). In accordance with the method, however, it is necessary to expose the cross section of a target sample to be analyzed by performing the cutting of the target sample or the like. As a result, the target sample which has the cross section once exposed cannot be incorporated into a semiconductor process any more. In the case of producing a sample as the target of analysis, the production thereof needs time and labor so that the method is not realistic when a large number of target samples are to be analyzed.

As examples of a non-destructive method for analyzing a target sample, there have been proposed an analysis method using an ultrasonic microscope and an analysis method using an electromagnetic ultrasonic sensor.

As shown in FIG. 5, the conventional analysis method using the ultrasonic microscope employs a piezoelectric element 102, which is used normally for the transmission and reception of an ultrasonic wave, to analyze a target sample 100 by using the ultrasonic wave. When the piezoelectric element 102 is used, a material serving as a medium 101 is necessary and the medium 101 such as a liquid, e.g., water or an adhesive should be interposed between the target sample 100 and the piezoelectric element 102 such that the target sample 100 is analyzed in the state in which the medium 101 is kept in contact with the target sample 100 and with the piezoelectric element 102. However, since the piezoelectric element 102 should be kept in tight contact with the target sample 100 with the medium 101 interposed therebetween, when a sensor composing the piezoelectric element 102 vibrates, the medium 101 and the target sample 100 also vibrate responsively to the sensor so that an ultrasonic wave other than the one reflected from the target sample 100, which is inherently necessary for analysis, also enters the sensor. Thus, it has been difficult to analyze the target sample in accordance with the conventional analysis method using the ultrasonic microscope.

By contrast, the conventional analysis method using the electromagnetic ultrasonic sensor (see, e.g., Patent Document 1: Japanese Laid-Open Patent Publication No.

HEI 9-257760) discloses a process of predicting the fatigue life of metal. Since the method generates an ultrasonic wave in a non-contact manner, an ultrasonic wave which is inherently necessary for analysis can be obtained in the sensor.

It is inherently necessary for the analysis of a target sample to include high-precision analysis of the internal structure of the target sample, as has been performed in accordance with the conventional analysis method using the SEM or TEM described above. However, the internal structure of the target sample cannot be analyzed in accordance with either the conventional analysis method using the ultrasonic microscope or the conventional analysis method using the electromagnetic ultrasonic sensor which is capable of solving the problems encountered by the conventional analysis method using the SEM or TEM. Thus, even in accordance with the conventional analysis method using the electromagnetic ultrasonic sensor capable of performing higher-precision analysis than the conventional method using the ultrasonic microscope, it has been difficult to perform high-precision analysis of the internal structure of a target sample, which can be performed in accordance with, e.g., the conventional analysis method using the SEM or TEM.

### SUMMARY OF THE INVENTION

To solve the problems described above, the present inventors have conducted elaborate studies and eventually made the finding that the above-mentioned object is attainable by performing the position control of at least one of a stage for holding a target sample and means for performing the transmission and reception of an ultrasonic wave. The present invention has been achieved based on the foregoing finding and, specifically, an apparatus for analyzing a semiconductor device according to an aspect of the present invention comprises: a stage for horizontally holding a semiconductor substrate serving as a target sample to be analyzed; an ultrasonic wave transmitting/receiving unit provided above the stage to transmit and receive an ultrasonic wave; a current control unit for applying a current to the ultrasonic wave transmitting/receiving unit such that a value of the current is variable; an ultrasonic wave transmitter provided in the ultrasonic wave transmitting/receiving unit to transmit an emitted ultrasonic wave to the target sample such that a frequency of the emitted ultrasonic wave is variable with a change in the value of the current applied from the current control unit; an ultrasonic wave receiver provided in the ultrasonic wave transmitting/receiving unit to receive a reflected ultrasonic wave which is the emitted ultrasonic wave transmitted from the ultrasonic wave transmitter and reflected from the target sample; and a position control unit for controlling at least one of the stage and the ultrasonic wave transmitting/receiving unit such that either one or both of the stage and the ultrasonic wave transmitting/receiving unit are movable in a horizontal direction, wherein the target sample is analyzed based on a frequency of the reflected ultrasonic wave having an amplitude thereof enlarged by resonance between the emitted ultrasonic wave and an unanalyzed material in the target sample and on analysis position information of the target sample obtained from a position of at least one of the stage and the ultrasonic wave transmitting/receiving unit.

In the apparatus for analyzing a semiconductor device according to the aspect of the present invention, the position control unit controls at least one of the stage and the ultrasonic wave transmitting/receiving unit such that either one or both of them are movable in the horizontal direction. This renders it possible to analyze the target sample by using the ultrasonic wave, while identifying a horizontal analysis position at the target sample. As a result, the internal structure of the target sample can be analyzed with high precision. In addition, the internal structure of the target sample can be analyzed with high precision without destroying or cutting the target sample.

Preferably, the apparatus for analyzing a semiconductor device according to another aspect of the present invention further comprises: an image processing unit for performing image processing based on the frequency of the reflected ultrasonic wave having the amplitude thereof enlarged by the resonance between the emitted ultrasonic wave and the unanalyzed material in the target sample.

The arrangement allows the identification of the material composing the target sample and the identification of the region occupied by the material and thereby allows high-precision analysis of the internal structure of the target sample.

In the apparatus for analyzing a semiconductor device according to still another aspect of the present invention, the image processing unit preferably holds a resonance frequency of a material composing the target sample as data.

The arrangement allows easy identification of the material composing the target sample based on the frequency of the emitted ultrasonic wave and on the frequency of the reflected ultrasonic wave having the amplitude thereof enlarged by the resonance between the emitted ultrasonic wave and the unanalyzed material in the target sample

In the apparatus for analyzing a semiconductor device according to yet another aspect of the present invention, the position control unit preferably controls at least one of the stage and the ultrasonic wave transmitting/receiving unit such that either one or both of the stage and the ultrasonic wave transmitting/receiving unit are movable not only in the horizontal direction but also in a vertical direction.

The arrangement allows position control in accordance with the thickness of the target sample.

Preferably, the apparatus for analyzing a semiconductor device according to still another aspect of the present invention further comprises: a first auxiliary ultrasonic wave transmitting/receiving unit and a second auxiliary ultrasonic wave transmitting/receiving unit which are arranged in parallel with the ultrasonic wave transmitting/receiving unit interposed therebetween to transmit and receive the ultrasonic wave.

The arrangement allows the emitted ultrasonic wave transmitted from the ultrasonic wave transmitting/receiving unit to interfere with the ultrasonic wave from each of the first and second auxiliary ultrasonic wave transmitting/receiving units which are adjacent to each other and thereby allows the intensification of the emitted ultrasonic wave transmitted from the ultrasonic wave transmitting/receiving unit.

A method for analyzing a semiconductor device according to an aspect of the present invention analyzes a semiconductor substrate held horizontally on a stage to serve as a target sample to be analyzed based on a frequency of an emitted ultrasonic wave transmitted from an ultrasonic wave transmitting/receiving unit to the semiconductor substrate and on a frequency of a reflected ultrasonic wave which is the emitted ultrasonic wave transmitted and reflected from the target sample and has an amplitude thereof enlarged by resonance between the emitted ultrasonic wave and an unanalyzed material in the target sample and comprises the steps of: (a) applying a current to the ultrasonic wave transmitting/receiving unit such that a value of the current is variable; (b) transmitting the emitted ultrasonic wave to the target sample such that the frequency of the emitted ultrasonic wave is variable with a change in the value of the current; (c) receiving the reflected ultrasonic wave; (d) controlling at least one of the stage and the ultrasonic wave transmitting/receiving unit such that either one or both of the stage and the ultrasonic wave transmitting/receiving unit are movable in a horizontal direction; and (e) analyzing the target sample based on the frequency of the reflected ultrasonic wave having the amplitude thereof enlarged by the resonance between the emitted ultrasonic wave and the unanalyzed material in the target sample and on analysis position information of the target sample obtained from a position of at least one of the stage and the ultrasonic wave transmitting/receiving unit.

The method for analyzing a semiconductor device according to the aspect of the present invention controls at least one of the stage and the ultrasonic wave transmitting/receiving unit such that either one or both of them are movable in the horizontal direction. This renders it possible to analyze the target sample by using the ultrasonic wave, while identifying a horizontal analysis position at the target sample. As a result, the internal structure of the target sample can be analyzed with high precision. In addition, the internal structure of the target sample can be analyzed with high precision without destroying or cutting the target sample.

In the method for analyzing a semiconductor device according to another aspect of the present invention, the step (e) preferably includes the step of performing image processing based on the frequency of the reflected ultrasonic wave having the amplitude thereof enlarged by the resonance between the emitted ultrasonic wave and the unanalyzed material in the target sample and on the analysis position information.

The arrangement allows the identification of the material composing the target sample and the identification of the region occupied by the material and thereby allows high-precision analysis of the internal structure of the target sample.

In the method for analyzing a semiconductor device according to still another aspect of the present invention, the step (d) preferably includes the step of controlling at least one of the stage and the ultrasonic wave transmitting/receiving unit such that either one or both of the stage and the ultrasonic wave transmitting/receiving unit are movable not only in the horizontal direction but also in a vertical direction.

The arrangement allows position control in accordance with the thickness of the target sample.

In the method for analyzing a semiconductor device according to yet another aspect of the present invention, the target sample is preferably the semiconductor substrate comprising a conductive film on an upper portion thereof.

The arrangement allows the analysis of the target sample by electromagnetic acoustic resonance.

In the method for analyzing a semiconductor device according to still another aspect of the present invention, a film having an etching selectivity to the semiconductor substrate is preferably interposed between the semiconductor substrate and the conductive film.

Since the arrangement facilitates delamination from the semiconductor substrate, a process subsequent to analysis can be performed continuously with respect to the post-analysis target sample. Accordingly, it becomes possible to perform comparative evaluation of size and configuration data and electric characteristics performed after the completion of the process.

In the method for analyzing a semiconductor device according to yet another aspect of the present invention, the film having the etching selectivity is preferably a resist film.

By thus using the resist film, it is delaminated easily and excellent in surface flatness after coating so that the resist film is preferred as a material to be interposed between the semiconductor substrate and the conductive film.

Preferably, the method for analyzing a semiconductor device according to still another aspect of the present invention further uses the ultrasonic wave transmitted and received by a first auxiliary ultrasonic wave transmitting/receiving unit and a second auxiliary ultrasonic wave transmitting/receiving unit which are arranged in parallel with the ultrasonic wave transmitting/receiving unit interposed therebetween to transmit and receive the ultrasonic wave, wherein the step (a) preferably includes the step of applying a current to each of the first and second auxiliary ultrasonic wave transmitting/receiving units such that the applied current has a phase sifted by 180° C. from a phase of the current applied to the ultrasonic wave transmitting/receiving unit.

The arrangement allows the emitted ultrasonic wave transmitted from the ultrasonic wave transmitting/receiving unit to interfere with the ultrasonic wave from each of the first and second auxiliary ultrasonic wave transmitting/receiving units which are adjacent to each other and thereby allows the intensification of the emitted ultrasonic wave from the ultrasonic wave transmitting/receiving unit.

Thus, the apparatus and method for analyzing a semiconductor device according to the aspect of the present invention performs the position control of at least one of the stage on which the target sample is placed and the ultrasonic wave transmitting/receiving unit for transmitting and receiving the ultrasonic wave. This renders it possible to analyze the target sample by using an electromagnetic ultrasonic wave, while identifying the horizontal analysis position at the target sample. Accordingly, the internal structure of the target sample can be analyzed with high precision without cutting or destroying the target sample, which is performed in the SEM or TEM.

### BRIEF DESCRIPTION OF THE DRAWINGS

FIG. 1 is a view showing the structure of an apparatus for analyzing a semiconductor device according to an embodiment of the present invention;

FIG. 2 is a schematic diagram for illustrating the structure of an electromagnetic ultrasonic wave transmitting/receiving unit in the apparatus for analyzing a semiconductor device according to the embodiment and the principle of operation thereof;

FIG. 3 is a schematic diagram for illustrating a variation of the electromagnetic ultrasonic wave transmitting/receiving unit in the apparatus for analyzing a semiconductor device according to the embodiment; FIG. 4 is a cross-sectional view for illustrating an example of the apparatus and method for analyzing a semiconductor device according to the embodiment; and

FIG. 5 is a cross-sectional view for illustrating a conventional method for analyzing a semiconductor device.

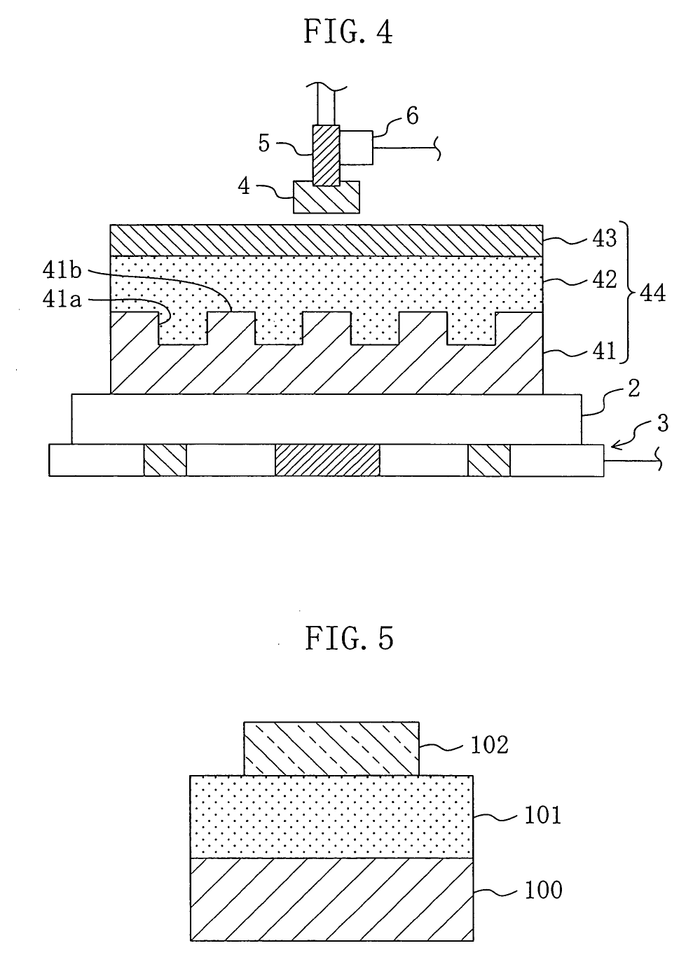

### DETAILED DESCRIPTION OF THE INVENTION

Referring now to the drawings, a description will be given herein below to an apparatus and method for analyzing a semiconductor device according to an embodiment of the present invention, specifically an apparatus and method for analyzing a semiconductor substrate as a target sample to be analyzed by using an electromagnetic ultrasonic wave.

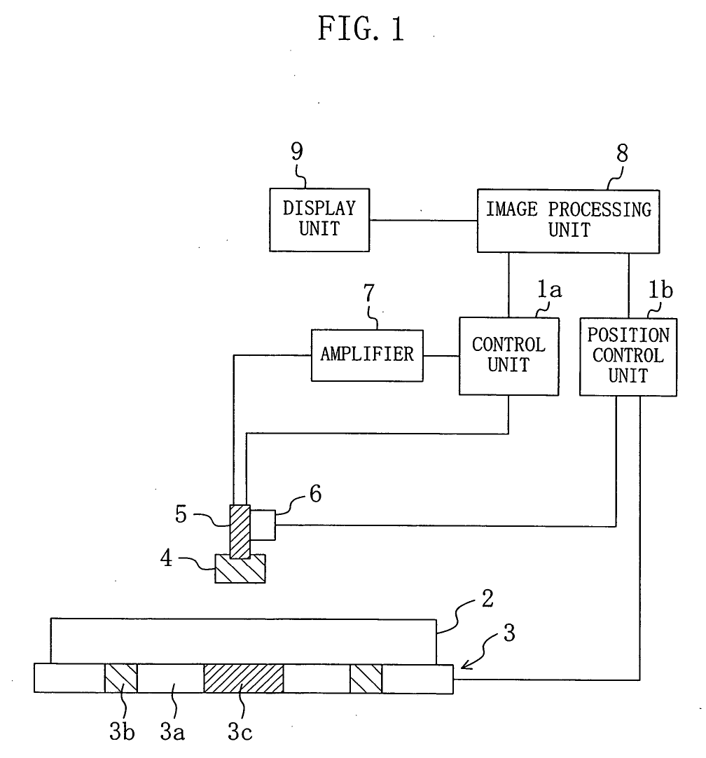

FIG. 1 is a structural view of the apparatus for analyzing a semiconductor device according to the embodiment.

The apparatus for analyzing a semiconductor device according to the embodiment comprises: a control unit 1a; a position control unit 1b; a stage 2; a first driving unit 3; an ultrasonic wave transmitting/receiving unit 4; a support rod 5; a second driving unit 6; an amplifier 7: an image processing unit 8; and a display unit 9.

The control unit 1a allows the detection of the frequency of a reflected ultrasonic wave having an amplitude thereof enlarged by resonance between an emitted ultrasonic wave and an unanalyzed material in the target sample and thereby allows the analysis of the target sample. The control unit 1a also has a mechanism for applying a current to the ultrasonic wave transmitting/receiving unit 4 such that the value of the current is variable.

The position control unit 1b controls the stage 2 and the ultrasonic wave transmitting/receiving unit 4 in horizontal and vertical directions. Although the description has been given to the case where the single position control unit 1b performs the position control of each of the stage 2 and the ultrasonic wave transmitting/receiving unit 4, a structure in which the corresponding number of position control units are provided to individually and independently control the stage 2 and the ultrasonic wave transmitting/receiving unit 4 may also be adopted instead.

The stage 2 is movable in horizontal and vertical directions and horizontally holds the target sample.

The first driving unit 3 comprises an X-direction position control rail 3a, a Y-direction position control rail 3b, and a Z-direction position control screw 3c and moves the stage 2 in the horizontal and vertical directions upon receipt of controls signals from the position control unit 1b.

The ultrasonic wave transmitting/receiving unit 4 having, e.g., an electro-magnetic ultrasonic sensor is movable in horizontal and vertical directions and comprises an ultrasonic wave transmitter and an ultrasonic wave receiver. The ultrasonic wave transmitter transmits an emitted ultrasonic wave to the target sample on the stage 2 such that the frequency thereof is variable with changes in the value of an RF current applied from the control unit 1a. On the other hand, the ultrasonic wave receiver receives a reflected ultrasonic wave which is the emitted ultrasonic wave reflected from the target sample on the stage 2.

The support rod 5 functions to support the ultrasonic wave transmitting/receiving unit 4 and is movable in horizontal and vertical directions in conjunction with the ultrasonic wave transmitting/receiving unit 4.

The second driving unit 6 receives control signals from the position control unit 1b and moves the ultrasonic wave transmitting/receiving unit 4 in conjunction with the support rod 5 in the horizontal and vertical directions.

The amplifier 7 amplifies an electric signal indicative of the frequency of the reflected ultrasonic wave that has been received by the ultrasonic wave receiver of the ultrasonic wave transmitting/receiving unit 4 and outputs the amplified electric signal as an ultrasonic characteristic to the control unit 1a.

The image processing unit 8 acquires the ultrasonic characteristic from the control unit 1a, acquires, from the position control unit 1b, the analysis position information of the target sample obtained from the position information of each of the stage 2 and the ultrasonic wave transmitting/receiving unit 4, processes these information items, and outputs the processed information items to the display unit 9 such that an image of the internal structure of the target sample is displayed. The image processing unit 8 also holds, as data, the resonance frequency of each material and substance composing the target sample in an internal memory thereof and identifies the material or substance that has caused resonance through comparison with the ultrasonic characteristic acquired from the control unit 1a.

The display unit 9 displays an image of the internal structure of the target sample based on the signal received from the image processing unit 8.

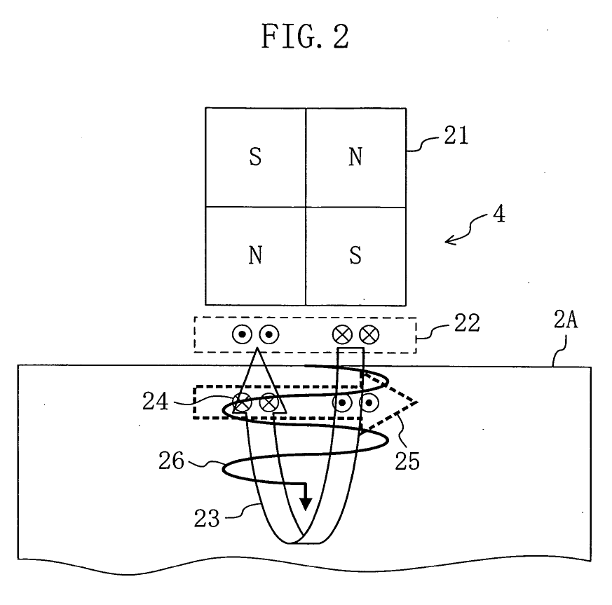

The apparatus for analyzing a semiconductor device thus constituted according to the embodiment of the present invention and an analysis method using the apparatus will be described specifically with reference to FIGS. 1 and 2 mentioned above.

FIG. 2 is a schematic diagram for illustrating the principle of electromagnetic acoustic resonance used in the apparatus and method for analyzing a semiconductor device according to the embodiment.

As shown in FIG. 2, the electromagnetic ultrasonic wave transmitting/receiving unit 4 is provided with a magnet 21 and with a spiral flat coil 22 such that the constitution of the electromagnetic ultrasonic wave transmitting/receiving unit 4 implements the functions of the electromagnetic ultrasonic wave transmitter and receiver described above. A conductive film 2A is formed on the uppermost surface of the target sample on the stage 2 opposing the magnet 21 with the flat coil 22 interposed therebetween.

The magnet 21 has formed a magnetostatic field 23. When the RF current is applied from the control unit 1a to the flat coil 22 such that the current value is variable, an eddy current 24 reverse in direction to the current flowing in the flat coil 22 is generated in the conductive film 2A. As a result, a Lorentz force 25 in accordance with the Fleming's left-hand rule occurs to exert influence on free electrons in the conductive film 2A, so that an emitted ultrasonic wave 26 traveling toward the inside of the conductive film 2A occurs. The emitted ultrasonic wave 26 propagates in the target sample and undergoes the process reverse to the foregoing phenomenon due to a reflected ultrasonic wave which is the emitted ultrasonic wave reflected from inside the target sample, whereby an electric signal is detected in the flat coil 22. The detected electric signal is amplified via the amplifier 7 and outputted as the ultrasonic characteristic to the control unit 1a.

Subsequently, the image processing unit 8 acquires the resonance frequency as the ultrasonic characteristic from the control unit 1a and compares the acquired resonance frequency with each of the intrinsic resonance frequencies of the individual materials and substances composing the target sample that have been held in advance, whereby the materials and substances composing the target sample are identified. In addition, the regions of the target sample in which the individual materials and substances are present are measured from the speed, attenuation coefficient, and the like of the ultrasonic wave as the ultrasonic characteristics. Further, the analysis position information of the target sample is acquired from the position control unit 1b. Then, image processing is performed by using the identified materials and substances, the regions where they are present, and the analysis position information in combination and the result of the image processing is outputted to the display unit 9. By the process described above, the internal structure of the target sample is analyzed with high precision.

A specific description will be given to the position control unit 1b.

As described above, the position control unit 1b controls the positions of the stage 2 and the ultrasonic wave transmitting/receiving unit 4 such that they are movable in the horizontal and vertical directions via the first and second driving units 3 and 6. The following is an exemplary operation of the control. First, to implement the control in the horizontal direction, rough positional adjustment is performed by moving the position of the stage 2 on which the target sample is placed such that the emitted ultrasonic wave from the ultrasonic wave transmitting/receiving unit 4 is directed to the desired region of the target sample, while fine adjustment is performed by moving the position of the ultrasonic wave transmitting/receiving unit 4 such that the emitted ultrasonic wave from the ultrasonic wave transmitting/receiving unit 4 is directed precisely to a desired analysis position at the target sample. By further moving the ultrasonic wave transmitting/receiving unit 4 in the horizontal direction in a scanning manner, while transmitting the emitted ultrasonic wave from the ultrasonic wave transmitting/receiving unit 4, it becomes possible to analyze the internal structure of the target sample with high precision, while obtaining information on a two-dimensional analysis position at the target sample. As for the control in the vertical direction, it is implemented by moving the stage 2 and the ultrasonic wave transmitting/receiving unit 4 in the vertical direction in accordance with, e.g., the thickness of the target sample or the like. Although the description has been given thus far to the case where the position control unit 1b moves both of the stage 2 and the ultrasonic wave transmitting/receiving unit 4, the position control unit 1a may also control one of the stage 2 and the ultrasonic wave transmitting/receiving unit 4 such that it is movable, depending on the case. If consideration is given to, e.g., the size of the stage 2 which is larger than that of the ultrasonic wave transmitting/receiving unit 4, a structure which performs the position control of only the ultrasonic wave transmitting/receiving unit 4 may also be adopted.

Thus, in the method and apparatus for analyzing a semiconductor device according to the embodiment of the present invention, the position control unit 1b controls at least one of the stage 2 and the ultrasonic wave transmitting/receiving unit 4 such that either one or both of them are movable in the horizontal and vertical directions. This renders it possible to analyze the target sample by using an electromagnetic ultrasonic wave, while identifying an analysis position at the target sample. As a result, the internal structure of the target sample can be analyzed with high precision.

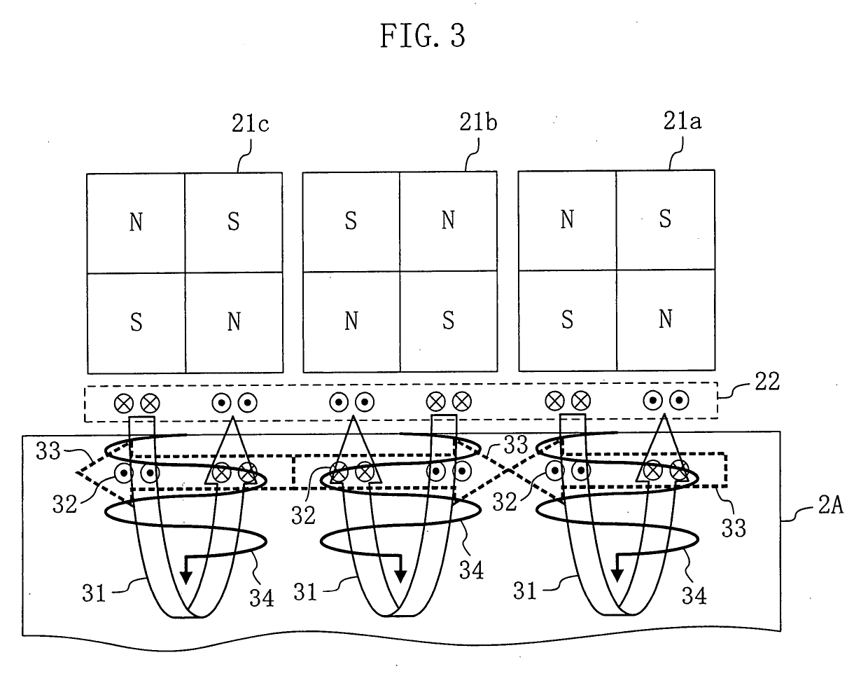

Referring to FIG. 3, a description will be given next to a variation of the structure of the ultrasonic wave transmitting/receiving unit 4 described above.

FIG. 3 shows the variation of the ultrasonic wave transmitting/receiving unit 4 according to the embodiment of the present invention.

As shown in FIG. 3, magnets 21a to 21c are arranged in parallel and a flat coil 22 is disposed under each of the magnets 21a to 21c. Thus, the variation of the ultrasonic wave transmitting/receiving unit 4 shown in FIG. 3 has the structure in which an auxiliary ultrasonic wave transmitting/receiving unit including the magnet 21a and an auxiliary ultrasonic wave transmitting/receiving unit including the magnet 21c are arranged with a main ultrasonic wave transmitting/receiving unit including the magnet 21b interposed therebetween. By applying a current to each of the two auxiliary ultrasonic wave transmitting/receiving units such that the phase of the applied current is shifted by 180° C. from that of a current applied to the main ultrasonic wave transmitting/receiving unit, magnetostatic fields 31, eddy currents 32, Lorentz forces 33, and ultrasonic waves 34 in the directions shown in the drawing occur. As a result, the ultrasonic wave 34 emitted from the main ultrasonic wave transmitting/receiving unit interferes with the adjacent ultrasonic waves 34 so that the ultrasonic wave 34 emitted from the main ultrasonic wave transmitting/receiving unit is intensified.

### EXAMPLE

A description will be given herein below to an example of the apparatus and method for analyzing a semiconductor device according to the embodiment of the present invention.

FIG. 4 is a cross-sectional view of the principal portion of the semiconductor analyzing apparatus shown in FIG. 1. A sample 44 which is the target sample produced to be analyzable has been placed on the stage 2. The sample 44 has been fixed to the stage 2 by, e.g., an electrostatic chuck method or the like.

The sample 44 is composed of: a semiconductor substrate 41 having depressed portions 41a and projecting portions 41b and serving as the target sample; a resist 42 coated on the semiconductor substrate 41, which is used normally in a semiconductor process; and a metal film 43 made of aluminum deposited by, e.g., sputtering on the resist 42.

The reason for the deposition of the metal film 43 on the uppermost surface of the sample 44 is that, as described above by using FIG. 2, the phenomenon of electromagnetic acoustic resonance does not occur unless a conductive film is on the uppermost surface. In the case of forming wiring having, e.g., a damascene structure, therefore, the internal structure can be analyzed by using a semiconductor substrate in that state only after copper plating has been performed already.

The reason for the coating of the resist 42 on the semiconductor substrate 41 as the target sample is that, since the coated resist 42 is excellent in surface flatness and can be delaminated easily together with the metal film 43, continuous evaluation of the target sample can be performed after a processing step subsequent to the delamination. However, a structure in which a material such as, e.g., an oxide film is used instead of the resist 42 may also be adopted provided that it has an etching selectivity to the semiconductor substrate 41 serving as the target sample, because the material can also be delaminated easily. More preferably, a material having an etching selectivity to the semiconductor substrate 41 is a film which allows easy surface flattening thereof.

Although the description has been given thus far to the case where sputtering is used as a method for depositing the metal film 43, a method using plating or the like may also be used instead.

In this state, the position control unit 1b moves the stage 2 in the horizontal direction via the first driving unit 3 and moves the support rod 5 in the horizontal direction via the second driving unit 6, thereby moving the ultrasonic wave transmitting/receiving unit 4 to an optimum position. The position control unit 1b can also move at least one of the stage 2 and the ultrasonic wave transmitting/receiving unit 4 in the vertical direction in accordance with the thickness of the sample 44.

The control unit 1a applies an RF current to the ultrasonic wave receiver of the ultrasonic wave transmitting/receiving unit 4, while varying the value of the current. Then, the ultrasonic wave receiver directs the emitted ultrasonic wave to the sample 44 such that the frequency thereof is variable with changes in the value of the applied RF current. Subsequently, the ultrasonic wave receiver receives a reflected ultrasonic wave which is the emitted ultrasonic wave reflected from inside the sample 44 and converts the reflected ultrasonic wave to an electric signal. The electric signal resulting from the conversion is amplified via the amplifier 7 and outputted as an ultrasonic characteristic to the control unit 1a.

Then, the image processing unit 8 acquires the resonance frequency as the ultrasonic characteristic from the control unit 1a, compares the acquired resonance frequency with the inherent resonance frequencies of the individual materials and substances composing the semiconductor substrate 41 that have been held in advance, and thereby identifies the materials and substances composing the semiconductor substrate 41. The image processing unit 8 also measures the regions of the semiconductor substrate 41 in which the individual materials and substances are present from the speed, attenuation coefficient, and the like of the ultrasonic wave as the ultrasonic characteristics. For example, the image processing unit 8 is capable of determining the depth of each of the depressed portions 41a of the semiconductor substrate 41 from the time at which the control unit 1a received the reflected ultrasonic wave from the bottom of the depressed portion 41a and from the time at which the control unit 1a received the reflected ultrasonic wave from the upper part of each of the projecting portions 41a of the semiconductor substrate 41. By further scanning the ultrasonic wave transmitting/receiving unit 4 in the horizontal direction at a given speed by using the position control unit 1b, while transmitting the ultrasonic wave from the ultrasonic wave transmitter of the ultrasonic wave transmitting/receiving unit 4, it becomes possible to analyze the internal structure of the semiconductor substrate 41, while obtaining information on the two-dimensional analysis position at the semiconductor substrate 41. For example, the distance between the depressed portions 41a can be determined precisely. Then, the materials and substances thus identified, the regions where they are present, and the information on the analysis samples are processed and outputted in combination to the display unit 9. By the foregoing process, the internal structure of the target sample can be analyzed with high precision.

As described above, the present invention is applied preferably to the apparatus and method for analyzing the internal structure of a semiconductor device without destroying or cutting the semiconductor device.

What is claimed is:

1. An apparatus for analyzing a semiconductor device, the apparatus comprising:
a stage for horizontally holding a semiconductor substrate serving as a target sample to be analyzed;
an ultrasonic wave transmitting/receiving unit provided above the stage to transmit and receive an ultrasonic wave;
a current control unit for applying a current to the ultrasonic wave transmitting/receiving unit such that a value of the current is variable;
an ultrasonic wave transmitter provided in the ultrasonic wave transmitting/receiving unit to transmit an emitted ultrasonic wave to the target sample such that a frequency of the emitted ultrasonic wave is variable with a change in the value of the current applied from the current control unit;
an ultrasonic wave receiver provided in the ultrasonic wave transmitting/receiving unit to receive a reflected ultrasonic wave which is the emitted ultrasonic wave transmitted from the ultrasonic wave transmitter and reflected from the target sample; and
a position control unit for controlling at least one of the stage and the ultrasonic wave transmitting/receiving unit such that either one or both of the stage and the ultrasonic wave transmitting/receiving unit are movable in a horizontal direction, wherein
the target sample is analyzed based on a frequency of the reflected ultrasonic wave having an amplitude thereof enlarged by resonance between the emitted ultrasonic wave and an unanalyzed material in the target sample and on analysis position information of the target sample obtained from a position of at least one of the stage and the ultrasonic wave transmitting/receiving unit.

2. The apparatus of claim 1, further comprising:
an image processing unit for performing image processing based on the frequency of the reflected ultrasonic wave having the amplitude thereof enlarged by the resonance between the emitted ultrasonic wave and the unanalyzed material in the target sample.

3. The apparatus of claim 2, wherein the image processing unit holds a resonance frequency of a material composing the target sample as data.

4. The apparatus of claim 1, wherein the position control unit controls at least one of the stage and the ultrasonic wave transmitting/receiving unit such that either one or both of the stage and the ultrasonic wave transmitting/receiving unit are movable not only in the horizontal direction but also in a vertical direction.

5. The apparatus of claim 1, further comprising:
a first auxiliary ultrasonic wave transmitting/receiving unit and a second auxiliary ultrasonic wave transmitting/receiving unit which are arranged in parallel with the ultrasonic wave transmitting/receiving unit interposed therebetween to transmit and receive the ultrasonic wave.

6. A method for analyzing a semiconductor device, the method analyzing a semiconductor substrate held horizontally on a stage to serve as a target sample to be analyzed based on a frequency of an emitted ultrasonic wave transmitted from an ultrasonic wave transmitting/receiving unit to the semiconductor substrate and on a frequency of a reflected ultrasonic wave which is the emitted ultrasonic wave transmitted and reflected from the target sample and has an amplitude thereof enlarged by resonance between the emitted ultrasonic wave and an unanalyzed material in the target sample and comprising the steps of:
(a) applying a current to the ultrasonic wave transmitting/receiving unit such that a value of the current is variable;
(b) transmitting the emitted ultrasonic wave to the target sample such that the frequency of the emitted ultrasonic wave is variable with a change in the value of the current;
(c) receiving the reflected ultrasonic wave;
(d) controlling at least one of the stage and the ultrasonic wave transmitting/receiving unit such that either one or both of the stage and the ultrasonic wave transmitting/receiving unit are movable in a horizontal direction; and
(e) analyzing the target sample based on the frequency of the reflected ultrasonic wave having the amplitude thereof enlarged by the resonance between the emitted ultrasonic wave and the unanalyzed material in the target sample and on analysis position information of the target sample obtained from a position of at least one of the stage and the ultrasonic wave transmitting/receiving unit.

7. The method of claim 6, wherein the step (e) includes the step of performing image processing based on the frequency of the reflected ultrasonic wave having the amplitude thereof enlarged by the resonance between the emitted ultrasonic wave and the unanalyzed material in the target sample and on the analysis position information.

8. The method of claim 6, wherein the step (d) includes the step of controlling at least one of the stage and the ultrasonic wave transmitting/receiving unit such that either one or both of the stage and the ultrasonic wave transmitting/receiving unit are movable not only in the horizontal direction but also in a vertical direction.

9. The method of claim 6, wherein the target sample is the semiconductor substrate comprising a conductive film on an upper portion thereof.

10. The method of claim 9, wherein a film having an etching selectivity to the semiconductor substrate is interposed between the semiconductor substrate and the conductive film.

11. The method of claim 10, wherein the film having the etching selectivity is a resist film.

12. The method of claim 6, further using the ultrasonic wave transmitted and received by a first auxiliary ultrasonic wave transmitting/receiving unit and a second auxiliary ultrasonic wave transmitting/receiving unit which are arranged in parallel with the ultrasonic wave transmitting/receiving unit interposed therebetween to transmit and receive the ultrasonic wave, wherein
the step (a) includes the step of applying a current to each of the first and second auxiliary ultrasonic wave transmitting/receiving units such that the applied current has a phase sifted by 180° C. from a phase of the current applied to the ultrasonic wave transmitting/receiving unit.
